(19) United States
(12) Patent Application Publication
(10) Pub. No.: US 2017/0074817 A1
(43) Pub. Date: Mar. 16, 2017

(54) ANALYSIS DEVICE AND ANALYSIS METHOD

(71) Applicant: Seiko Epson Corporation, Tokyo (JP)

(72) Inventor: Makoto KATASE, Azumino (JP)

(21) Appl. No.: 15/252,756

(22) Filed: Aug. 31, 2016

(30) Foreign Application Priority Data
Sep. 10, 2015 (JP) 2015-178232
Jun. 2, 2016 (JP) 2016-110689

(51) Int. Cl. G01N 27/327; G01N 27/30

(52) U.S. Cl. CPC G01N 27/3273; G01N 27/301

(57) ABSTRACT

An analysis device includes an electrode which induces a surface current, a circuit which is electrically connected to the electrode, and guard wirings, each of which guards part of the circuit. A guard voltage to be input to the guard wirings is based on the non-inverting input voltage of differential amplifiers included in the circuit. The electrode preferably includes a working electrode provided with an enzyme layer which senses glucose and a counter electrode which receives an electric current generated in the working electrode.

### BACKGROUND

1. Technical Field

The present invention relates to an analysis device and an analysis method.

2. Related Art

With the recent increase in health consciousness, health care is performed by measuring a blood glucose level, a lactic acid level, an antibody level, an enzyme level, or the like in a body fluid such as blood, interstitial fluid, saliva, or sweat of a specific individual over time.

For example, for diabetic patients, it is particularly important to measure (monitor) a blood glucose level over time.

Diabetic patients are divided into type I and type II according to the symptoms, however, in both types, insulin secretion from the pancreas is not normal. Due to this, the internal organs cannot normally incorporate glucose, and therefore, metabolic abnormality occurs and also the body weight decreases. Moreover, it is known that when hyperglycemia continues for a long period of time, serious complications such as “diabetic retinopathy”, “diabetic nephropathy”, “diabetic microvascular disease”, and “diabetic neuropathy” are developed.

The current situation is that in order to prevent the development of such serious complications, a therapeutic approach to maintain a blood glucose level within a normal range by administering insulin by injection (injection administration) is adopted for patients when hyperglycemia continues for a long period of time.

In type I diabetic patients, insulin is not secreted at all due to a pancreatic disease, and therefore, it is necessary to measure a blood glucose level by blood collection several times a day (at least four times, before meal and before going to bed), and administer insulin. As for the timing of administration, in order to suppress an excess increase in the blood glucose level after meal, the blood glucose level before meal is measured and the calories of the meal is calculated beforehand, and then the dose of insulin is determined and insulin is administered by injection before meal.

Further, a symptom called “dawn phenomenon” is known as an increase in the blood glucose level, and the blood glucose level increases at dawn at 8 to 10 hours after going to bed. However, in order to manage this physiological phenomenon, it is necessary to wake up once before dawn and measure the blood glucose level by blood collection, and if the blood glucose level is high, it is necessary to administer insulin. In this manner, diabetic patients (particularly type I diabetic patients) are compelled to live a life while caring about the blood glucose level all day long.

The current situation is that in order to reduce the burden of daily life on such patients and families who support the patients, that is, in order to improve the QOL (Quality of Life) of the patients and families of the patients, the development of an artificial pancreas or a device equivalent thereto has been demanded. Due to this, first, it is necessary to measure and control the blood glucose level in patients over time (continuously) and automatically.

For example, a device so-called a continuous glucose monitor (CGM) device utilizing an enzymatic reaction for use in monitoring the glucose level in the interstitial fluid of a patient over a long period of time by embedding a blood glucose level sensor in the body (subcutaneous tissue) has been proposed.

The basic principle of the quantitative determination of glucose using an enzymatic reaction is that in the presence of an enzyme (for example, glucose oxidase), when glucose and oxygen are present in the vicinity of the enzyme, gluconic acid and hydrogen peroxide are generated. By electrically decomposing the generated hydrogen peroxide, an electric current is generated, and by measuring the amount of the generated electric current (electric current value), the amount of hydrogen peroxide can be quantitatively determined. Therefore, a glucose level can be calculated based on the quantitatively determined amount of hydrogen peroxide.

By using such an enzymatic reaction, it has become possible to monitor a blood glucose level continuously with the sensor embedded in the body.

However, the current situation is that with the use of a sensor which calculates a glucose level (blood glucose level), that is, a target measurement based on an electric current value measured in this manner, sufficient reliability of the measurement is not obtained due to the disturbance noise of static electricity or the like.

In order to solve such a problem, for example, JP-A-2011-102729 (PTL 1) proposes that a blocking layer which blocks disturbance noise is provided on the surface of a chip included in a sensor. Further, JP-A-2004-184255 (PTL 2) proposes that a disturbance noise countermeasure section which absorbs disturbance noise is provided, however, even if such a blocking layer or a disturbance noise countermeasure section is provided, when a sensor signal has high impedance, small disturbance noise adversely affects a sensor signal, and therefore, there is a problem that the reliability of the obtained measurement is not improved as much as expected. Further, there is a problem that in a micro current sensor, a leakage current in the conduction path of a signal adversely affects a sensor signal aside from disturbance noise and disturbs a measurement.

Such problems occur similarly also in other sensors which measure a lactic acid level, an antibody level, an enzyme level, or the like as well as in a continuous glucose monitor (CGM) device which measures a blood glucose level (glucose concentration).

### SUMMARY

An advantage of some aspects of the invention is to provide an analysis device and an analysis method capable of calculating a target measurement with excellent accuracy without being adversely affected by disturbance noise and also without being adversely affected by a leakage current.

The advantage of the invention can be achieved by the following configurations.

An analysis device according to an aspect of the invention is an analysis device including an electrode which induces a surface current, a circuit which is electrically connected to the electrode, and a guard wiring which guards part of the circuit, wherein a guard voltage to be input to the guard wiring is based on the non-inverting input voltage of a differential amplifier included in the circuit.

According to this configuration, a target measurement can be calculated with excellent accuracy without being adversely affected by a leakage current and also without being adversely affected by disturbance noise.

In the analysis device according to the aspect of the invention, it is preferred that the electrode includes a working electrode provided with an enzyme layer which senses glucose and a counter electrode which receives an electric current generated in the working electrode.

By applying the analysis device according to the aspect of the invention to the analysis device including an electrode having such a configuration, a target measurement can be calculated with excellent accuracy without being adversely affected by a leakage current and also without being adversely affected by disturbance noise.

In the analysis device according to the aspect of the invention, it is preferred that the electrode further includes a reference electrode to be used for detecting the resistance of an electric current flowing through the working electrode.

By applying the analysis device according to the aspect of the invention to the analysis device including an electrode having such a configuration, a target measurement can be calculated with excellent accuracy without being adversely affected by a leakage current and also without being adversely affected by disturbance noise.

An analysis device according to an aspect of the invention includes an electrode which induces a surface current, a circuit which is electrically connected to the electrode, and a guard section which covers part of the circuit.

According to this configuration, a target measurement can be calculated with excellent accuracy without being adversely affected by a leakage current and also without being adversely affected by disturbance noise.

In the analysis device according to the aspect of the invention, it is preferred that the guard section covers part of a wiring constituting the circuit in the form of a cover cylinder.

According to this configuration, an electric current of the electrode can be more reliably protected by the guard section without coming into contact with body fluids and tissues.

In the analysis device according to the aspect of the invention, it is preferred that the electrode includes a working electrode provided with an enzyme layer which senses glucose and a counter electrode which receives an electric current generated in the working electrode.

By applying the analysis device according to the aspect of the invention to the analysis device including an electrode having such a configuration, a target measurement can be calculated with excellent accuracy without being adversely affected by a leakage current and also without being adversely affected by disturbance noise.

In the analysis device according to the aspect of the invention, it is preferred that the electrode further includes a reference electrode to be used for detecting the resistance of an electric current flowing through the working electrode.

By applying the analysis device according to the aspect of the invention to the analysis device including an electrode having such a configuration, a target measurement can be calculated with excellent accuracy without being adversely affected by a leakage current and also without being adversely affected by disturbance noise.

An analysis method according to an aspect of the invention is an analysis method which uses an analysis device including an electrode which induces a surface current, a circuit which is electrically connected to the electrode, and a guard wiring which guards part of the circuit, wherein a guard voltage to be input to the guard wiring is based on the non-inverting input voltage of a differential amplifier included in the circuit, and a target measurement is calculated.

According to this configuration, a target measurement can be calculated with excellent accuracy without being adversely affected by a leakage current and also without being adversely affected by disturbance noise.

### BRIEF DESCRIPTION OF THE DRAWINGS

The invention will be described with reference to the accompanying drawings, wherein like numbers reference like elements.

FIG. 1 is a perspective view schematically showing a first embodiment of an analysis device according to the invention and shows a state where a detachable section included in a detection element of the analysis device is attached to a main body section.

FIG. 2 is a perspective view schematically showing the first embodiment of the analysis device according to the invention and shows a state where the detachable section included in the detection element of the analysis device is detached from the main body section.

FIG. 3 is a side view showing a state where the detection element in the first embodiment of the analysis device according to the invention is attached to the skin.

FIG. 4 is an enlarged vertical cross-sectional view showing a cannula included in the detection element shown in FIG. 3.

FIG. 5 is a plan view showing a detection section included in the detection element shown in FIG. 3.

FIG. 6 is a vertical cross-sectional view showing the detection section included in the detection element shown in FIG. 3.

FIG. 7 is a view schematically showing a configuration of a circuit for driving the detection section included in the detection element shown in FIG. 3.

FIG. 8 is a plan view showing a detection section included in a detection element in a second embodiment of the analysis device according to the invention.

FIG. 9 is a vertical cross-sectional view taken along the line A-A in FIG. 8.

FIG. 10 is a vertical cross-sectional view showing another configuration example of the detection section included in the detection element in the second embodiment of the analysis device according to the invention.

FIG. 11 is a plan view showing a detection section included in a detection element in a third embodiment of the analysis device according to the invention.

FIG. 12 is a vertical cross-sectional view taken along the line B-B in FIG. 11.

FIG. 13 is a view schematically showing a configuration of a circuit for driving a detection section included in a detection element in a fourth embodiment of the analysis device according to the invention.

FIG. 14 is a flowchart showing a method for measuring a glucose level using the analysis device according to the invention.

FIG. 15 is a view schematically showing a configuration of a circuit for driving a detection section included in a detection element according to a related art.

### DESCRIPTION OF EXEMPLARY EMBODIMENTS

Hereinafter, an analysis device and an analysis method according to the invention will be described in detail based on embodiments shown in the accompanying drawings.

In this embodiment, a case where the analysis device according to the invention is applied to a continuous glucose monitor (CGM) device which continuously monitors a glucose level in the interstitial fluid over a long period of time will be described as an example.

### Analysis Device

### First Embodiment

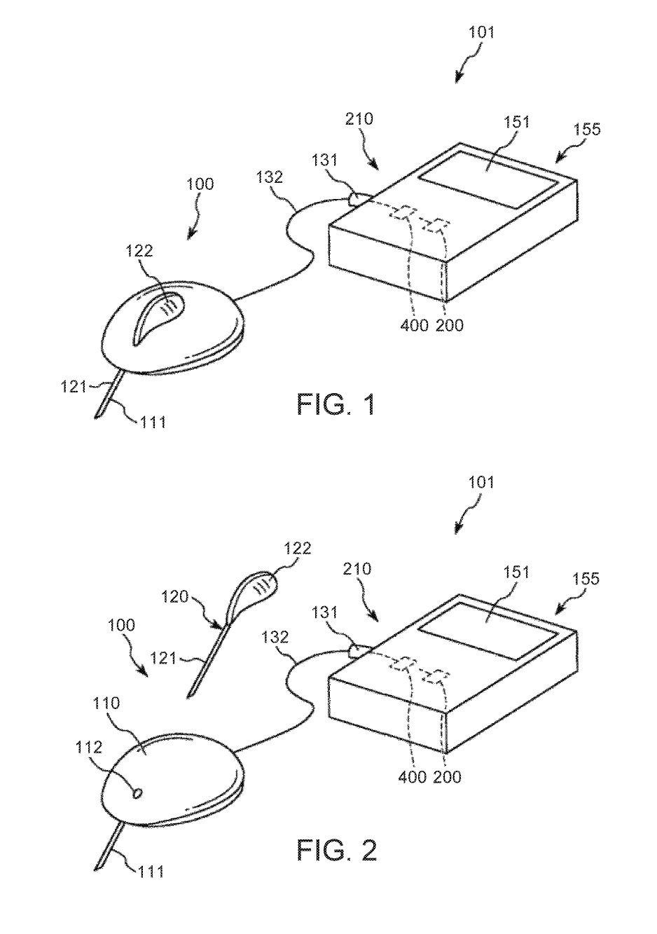

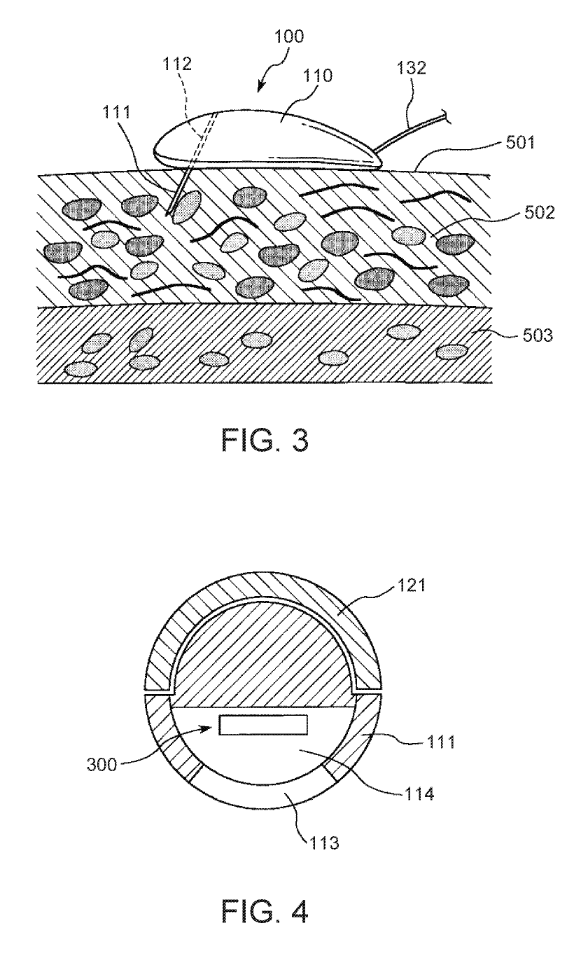

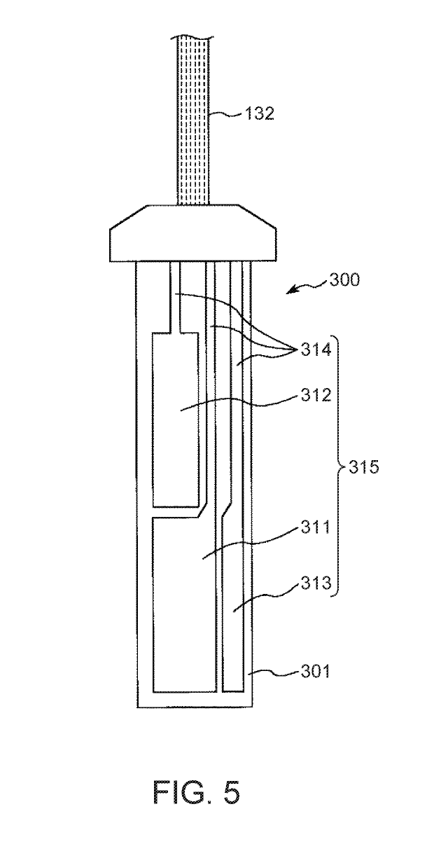

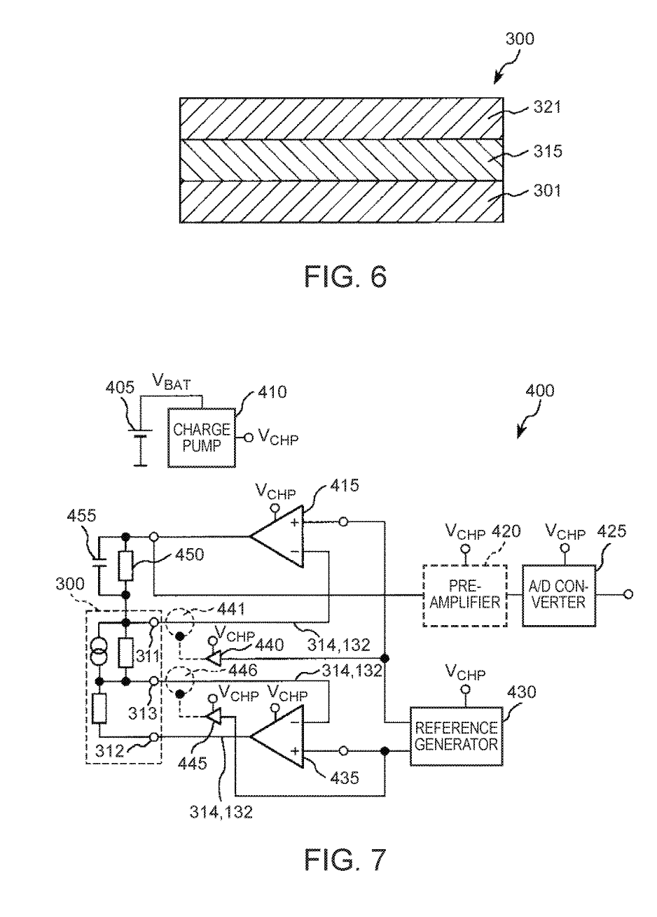

FIG. 1 is a perspective view schematically showing a first embodiment of an analysis device according to the invention and shows a state where a detachable section included in a detection element of the analysis device is attached to a main body section. FIG. 2 is a perspective view schematically showing the first embodiment of the analysis device according to the invention and shows a state where the detachable section included in the detection element of the analysis device is detached from the main body section. FIG. 3 is a side view showing a state where the detection element in the first embodiment of the analysis device according to the invention is attached to the skin. FIG. 4 is an enlarged vertical cross-sectional view showing a cannula included in the detection element shown in FIG. 3. FIG. 5 is a plan view showing a detection section included in the detection element shown in FIG. 3. FIG. 6 is a vertical cross-sectional view showing the detection section included in the detection element shown in FIG. 3. FIG. 7 is a view schematically showing a configuration of a circuit for driving the detection section included in the detection element shown in FIG. 3.

In the following description, in FIGS. 3, 4, and 6, the upper side is referred to as “upper”, and the lower side is referred to as “lower”. Further, in FIG. 5, the front side of the paper sheet is referred to as “upper”, and the rear side of the paper sheet is referred to as “lower”.

An analysis device 101 shown in FIGS. 1 and 2 is used by connecting a detection element 100 thereto, and includes the detection element 100, a calculation device 210 including a circuit 400 for obtaining an electric current based on a glucose level in the detection element 100 and a processing circuit 200 which analyzes the obtained electric current, a display section 155 including a monitor 151 which displays a measurement obtained by calculation by the calculation device 210, a connector 131 which attaches (connects) the detection element 100 to the display section 155, and a wiring 132 which connects the detection element 100 to the connector 131.

As shown in FIG. 3, the analysis device 101 can be used by attaching the detection element 100 to the skin of a wearer. In the skin of the wearer, an epidermis 501, a subcutaneous tissue 502, and a blood vessel 503 are located from the surface side, and interstitial fluid traveling from the blood vessel 503 is contained in the subcutaneous tissue 502.

As shown in FIGS. 1 to 4, the detection element 100 includes a main body section 110 which includes a cannula 111 to be inserted into the subcutaneous tissue 502 and a detachable section 120 which can be attached to and detached from the main body section 110 and includes a needle section 121 on a tip end side.

The detachable section 120 includes a gripping section 122 located on a proximal end side and the needle section 121 located on a tip end side, and is attached to the main body section 110 by inserting the needle section 121 into a through-hole 112 provided in the main body section 110 (see FIG. 1), and further can be detached by pulling out the needle section 121 in a state of gripping the gripping section 122 (see FIG. 2).

The needle section (insertion needle) 121 is sharp at the tip end and has a semi-cylindrical shape as a whole. When the detachable section 120 is attached to the main body section 110, the needle section 121 passes through the through-hole 112 and protrudes from the lower surface of the main body section 110, so that the needle section 121 surrounds part of the side surface of the cannula 111 as shown in FIG. 4. The cannula 111 is configured to be engaged with the needle section 121 so as to have a substantially cylindrical shape.

Therefore, when the main body section 110 is attached to the epidermis 501, the needle section 121 pierces the epidermis 501. However, at this time, the cannula 111 surrounded by the needle section 121 also pierces the epidermis 501 along with the needle section 121 and is inserted into the subcutaneous tissue 502.

Then, after this insertion of the needle section 121 accompanied with the cannula 111 into the subcutaneous tissue 502, by detaching the detachable section 120 from the main body section 110 by gripping the gripping section 122, the cannula 111 can be inserted (left) in the subcutaneous tissue 502. In this manner, when the main body section 110 is attached to the epidermis 501, the detachable section 120 (needle section 121) is used as a guiding member for percutaneously disposing the cannula 111 protruding from the main body section 110 in the subcutaneous tissue 502.

The main body section 110 has a dome shape as a whole and includes the cannula 111 protruding from the lower surface thereof. This main body section 110 includes an adhesive layer (not shown) on the lower surface and is attached (fixed) to the epidermis 501 by bringing this lower surface into contact with the epidermis 501. At this time, the cannula 111 is disposed in the subcutaneous tissue 502 by being guided by the needle section 121 described above.

The cannula 111 has a substantially cylindrical shape as a whole and part of the side surface has a cutout shape so that it can be engaged with the needle section 121. The cannula 111 includes a hollow section 114 constituted by a communication hole (through-hole) communicating from the proximal end to the tip end and also includes a window section 113 which opens the hollow section 114 to the outside of the cannula 111.

In the hollow section 114, a detection section 300 included in the main body section 110 is disposed. The interstitial fluid contained in the subcutaneous tissue 502 comes into contact with this detection section 300 through the window section 113. Due to this, by the detection section 300, glucose in the interstitial fluid is detected. Then, by attaching the main body section 110 to the epidermis 501, the cannula 111 can be disposed in the subcutaneous tissue 502 over a long period of time. Therefore, the detection of glucose in the interstitial fluid can be continuously performed. That is, the main body section 110 (detection element 100) is used in a CGMS (continuous glucose monitoring system) which continuously observes a glucose level in the interstitial fluid.

Here, the detection of glucose by the detection section 300 is performed using a principle as described below.

That is, in the presence of an enzyme (for example, glucose oxidase), when glucose and oxygen are present in the vicinity of the enzyme, gluconic acid and hydrogen peroxide are generated by an enzymatic reaction as shown in the following formula (1). Then, by measuring the amount of an electric current generated by electrical decomposition by applying a voltage (for example, 600 mV) to the generated hydrogen peroxide between a working electrode and a counter electrode, the amount of hydrogen peroxide can be quantitatively determined. Therefore, based on this quantitatively determined amount of hydrogen peroxide, the glucose level can be calculated.

When hydrogen peroxide is electrically decomposed, on a working electrode (anode) side, protons, oxygen, and electrons are generated by the electrical decomposition of hydrogen peroxide as shown in the following formula (2), and on a counter electrode (cathode) side, hydroxide ions are generated by reacting electrons supplied from the working electrode, and oxygen and water present in the vicinity of the electrode with one another as shown in the following formula (3).

Enzymatic reaction: glucose+O₂+H₂O→4 gluconic acid+H₂O₂ (1)

Working electrode: H₂O₂→O₂+2H⁺+2e⁻ (2)

Counter electrode: O₂+2H₂O+4e^{→}4OH⁻ (3)

Hereinafter, the detection section 300 which detects glucose using such a principle will be described in detail.

As shown in FIGS. 5 and 6, the detection section 300 includes a substrate 301, an electrode layer (electrode) 315, and a sensing layer (enzyme layer) 321. The sensing layer 321 is omitted in FIG. 5.

The substrate (base substrate) 301 supports the respective components (in this embodiment, the electrode layer 315 and the sensing layer 321) constituting the detection section 300.

As the constituent material of the substrate 301, a variety of materials can be used without being particularly limited as long as the material does not chemically react with air, water, body fluids, blood, or interstitial fluid, and is stable.

Specific examples thereof include inorganic materials such as glass and SUS (stainless steel), and resin materials such as amorphous polyarylate (PAR), polysulfone (PSF), polyethersulfone (PES), polyphenylene sulfide (PPS), polyether ether ketone (PEEK, another name: aromatic polyether ketone), polyimide (PI), polyetherimide (PEI), fluororesins (fluorocarbon polymers), nylon, polyamides (PA) including amides, and polyesters such as polyethylene terephthalate (PET), and among these, one type or two or more types in combination can be used.

The electrode layer 315 detects electrons generated by electrically decomposing hydrogen peroxide generated in the below-mentioned sensing layer 321, and measures the detected electrons as an electric current amount.

This electrode layer 315 is formed on the substrate 301 and includes a working electrode 311, a counter electrode 312, a reference electrode 313, and a wiring 314. In the following description, the working electrode 311, the counter electrode 312, and the reference electrode 313 are also referred to as “respective electrodes 311, 312, and 313”.

The respective electrodes 311, 312, and 313 are independently electrically connected to the circuit 400 and the processing circuit 200 through the wiring 314, the wiring 132, and the connector 131. According to this, an electric current value measured by the respective electrodes 311 and 312 (electrode layer 315) is transmitted to the circuit 400 and the processing circuit 200 included in the display section 155 through the wirings 314 and 132, and a glucose level in the interstitial fluid is calculated as a measurement by an analysis by the calculation device 210 including the processing circuit 200. Then, this measurement (glucose level) is displayed on the monitor 151, and thus, a wearer is continuously informed of the glucose level.

The constituent materials of the respective electrodes 311, 312, and 313 are not particularly limited as long as they can be used as an enzyme electrode, and examples thereof include metal materials such as gold, silver, platinum, and alloys containing these metals, metal oxide-based materials such as ITO (indium tin oxide), and carbon-based materials such as carbon (graphite).

The deposition of the respective electrodes 311, 312, and 313 can be performed by a sputtering method, a plating method, or a vacuum heating vapor deposition method in the case where the respective electrodes 311, 312, and 313 are constituted by platinum, gold, or an alloy thereof. Further, in the case where the respective electrodes 311, 312, and 313 are constituted by carbon graphite, the deposition can be achieved by mixing carbon graphite in a binder dissolved in a suitable solvent and applying the resulting mixture.

The sensing layer (enzyme layer) 321 is formed by being stacked on the electrode layer 315, that is, the sensing layer 321 is formed so as to cover the working electrode 311, the counter electrode 312, and the reference electrode 313. The sensing layer 321 generates hydrogen peroxide from glucose permeating from the interstitial fluid coming into contact with the upper surface thereof by an enzymatic reaction, and supplies the generated hydrogen peroxide to the above-mentioned electrode layer 315. The sensing layer 321 senses glucose by an enzymatic reaction in which hydrogen peroxide is generated from glucose.

This sensing layer 321 is a layer configured to contain an enzyme, and as described above, the detection element 100 detects (senses) glucose in the interstitial fluid, and therefore, as the enzyme, glucose oxidase (GOD) is preferably used. By using glucose oxidase, the enzymatic reaction represented by the above formula (1) can be made to proceed with high activity, and therefore, hydrogen peroxide can be reliably generated from glucose in the presence of O₂ and H₂O.

Further, in the sensing layer 321, other than the enzyme, a resin material is contained for the purpose of retaining the enzyme in the sensing layer 321.

The resin material is not particularly limited, but, for example, methyl cellulose (MC), acetyl cellulose (cellulose acetate), polyvinylpyrrolidone (PVP), polyvinyl alcohol (PVA), a polyvinyl alcohol-polyvinyl acetate copolymer (PVA-PVAc), or the like is preferably used, and among these, one type or two or more types in combination can be used. By using these resin materials, a decrease in the activity of the enzyme can be properly suppressed.

Further, in the sensing layer 321, a binder or a curing agent, and other than this, albumin, a phosphate buffer, or the like may be contained.

Examples of the binder or the curing agent include a material having two or more functional groups such as aldehyde and isocyanate in the molecule. By including such a binder or a curing agent in the sensing layer 321, the sensing layer 321 can retain the enzyme in the sensing layer 321 at a high retention ratio.

Specific examples of the binder or the curing agent include glutaraldehyde, toluene diisocyanate, and isophorone diisocyanate, and among these, one type or two or more types in combination can be used. Further, examples of the binder or the curing agent utilizing UV curability include a poly(vinyl alcohol)-styrylpyridinium compound (PVA-SbQ).

The sensing layer 321 containing such a binder or a curing agent can be obtained by curing a resin composition in which the binder or the curing agent, a resin material having a functional group capable of binding to a functional group contained in the binder or the curing agent, specifically, a hydroxy group, an amino group, an epoxy group, or the like at an end, and the enzyme are mixed with one another.

Further, examples of the albumin include human albumin and bovine albumin, and by including albumin, the protection and stabilization of the enzyme can be achieved.

Further, by including a phosphate buffer or the like, a variation in pH due to the enzymatic reaction can be suppressed.

The sensing layer 321 may be a layer constituted by two or more multiple layers other than a layer constituted by one layer as described above.

Examples of such a sensing layer 321 constituted by two or more multiple layers include a layer including the above-mentioned sensing layer as a (glucose) detection layer, and also including at least one layer selected from a (permeation) control layer, a noise removal layer, and a (an enzyme) protective layer, which is stacked on the upper or lower side of this detection layer.

The (permeation) control layer is stacked on the upper side of the (glucose) detection layer, and by this control layer, while suppressing or preventing the detection layer from coming into contact with a measurement target (interstitial fluid, and further blood), a function to allow oxygen and glucose to permeate is exhibited, and moreover, the layer has a function to control the permeability of oxygen and glucose.

Further, it is preferred that the (permeation) control layer having such a function is capable of allowing oxygen to permeate more than glucose. According to this, in the detection of glucose using the reactions shown in the above formulae (1) to (3), an apparent decrease in the measurement of glucose level due to a lack of oxygen can be properly suppressed or prevented. That is, the improvement of the detection accuracy of the measurement of glucose level can be achieved.

This (permeation) control layer is not particularly limited, but examples thereof include a layer in which a cross-linked structure is constructed by forming a urethane bond using a cross-linking agent such as an isocyanate compound and also using polyethylene glycol (PEG) which is a polymer having a terminal hydroxy group, 4-hydroxybutyl acrylate, and the like alone or in admixture.

Further, other than this, a layer constituted by aminopropyl polysiloxane or the like, in which a urea resin is formed using isocyanate and an amino group, is preferably used, and a layer constituted by a siloxane resin is more preferably used, and a layer constituted by polydimethylsiloxane is particularly preferably used.

The noise removal layer is stacked on the lower side of the (glucose) detection layer and has a function to prevent a decrease in the detection sensitivity for the measurement of glucose level caused by permeation of a compound such as acetaminophen, ascorbic acid, or uric acid, which may be contained in the interstitial fluid, through the sensing layer 321 to reach the electrode layer 315.

The constituent material of the noise removal layer is not particularly limited as long as it can exhibit the above-mentioned function, but examples thereof include methyl cellulose (MC), acetyl cellulose (cellulose acetate), polyvinylpyrrolidone (PVP), polyvinyl alcohol (PVA), a polyvinyl alcohol-polyvinyl acetate copolymer (PVA-PVAc), hydroxyethyl methacrylate, and poly (2-hydroxyethyl methacrylate) (HEMA), and among these, one type or two or more types in combination can be used.

In order to insolubilize the noise removal layer, an isocyanate-based compound may be added to the noise removal layer so that isocyanate can be used as a functional group, or a poly(vinyl alcohol)-styrylpyridinium compound (PVA-SbQ) or the like may be added to the noise removal layer so that UV curability can be utilized.

The noise removal layer may further contain albumin. According to this, the lower boundary surface (lower surface) of the (glucose) detection layer located on the noise removal layer can be protected.

The protective layer is a layer which is stacked on the (glucose) detection layer. In the case where the sensing layer 321 includes the (permeation) control layer, this protective layer is located between the (glucose) detection layer and the (permeation) control layer.

This protective layer has a function to protect the upper boundary surface (upper surface) of the (glucose) detection layer located under the protective layer.

The constituent material of this protective layer is not particularly limited as long as it can exhibit the above-mentioned function, but examples thereof include methyl cellulose (MC), acetyl cellulose (cellulose acetate), polyvinylpyrrolidone (PVP), polyvinyl alcohol (PVA), and polyvinyl alcohol-polyvinyl acetate copolymer (PVA-PVAc), and among these, one type or two or more types in combination can be used.

The protective layer may further contain a binder or a curing agent, albumin, or the like.

Examples of the binder or the curing agent include a material having two or more functional groups such as aldehyde and isocyanate in the molecule.

Specific examples of the binder or the curing agent include glutaraldehyde, toluene diisocyanate, and isophorone diisocyanate, and among these, one type or two or more types in combination can be used. Further, examples of the binder or the curing agent utilizing UV curability include a poly(vinyl alcohol) -styrylpyridinium compound (PVA-SbQ).

The protective layer containing such a binder or a curing agent can be obtained by curing a resin composition in which the binder or the curing agent, and a resin material having a functional group capable of binding to a functional group contained in the binder or the curing agent, specifically, a hydroxy group, an amino group, an epoxy group, or the like at an end are mixed with each other.

Further, examples of the albumin include human albumin and bovine albumin, and by including albumin, the protection and stabilization of the enzyme on the upper boundary surface (upper surface) of the (glucose) detection layer can be achieved.

In this embodiment, a case where, in the detection section 300, all of the working electrode 311, the counter electrode 312, the reference electrode 313, and the wiring 314 included in the electrode layer 315 are covered by the sensing layer 321 has been described, however, the configuration is not limited thereto, and the sensing layer 321 may be formed selectively on the working electrode 311 and the counter electrode 312, or the sensing layer 321 may be formed selectively on the working electrode 311.

Further, as shown in FIG. 7, the display section 155 has the circuit 400 which is disposed therein and electrically connected thereto through the wirings 314 and 132, and drives the detection section 300.

This circuit 400 includes a battery 405, a charge pump 410, a differential amplifier (transimpedance amplifier) 415, a differential amplifier (servo amplifier) 435, a preamplifier 420, an analog-to-digital converter (A/D converter) 425, a reference generator 430, and amplifiers 440 and 445.

To this circuit 400, the working electrode 311, the reference electrode 313, and the counter electrode 312 serving as electrodes for inducing a surface current and included in the detection section 300 are electrically connected.

More specifically, with reference to FIG. 7, the working electrode 311 is electrically connected to the inverting input (terminal) of the differential amplifier 415, the reference electrode 313 which is used for detecting the resistance of an electric current flowing through the working electrode 311 is electrically connected to the inverting input (terminal) of the differential amplifier 435, and the counter electrode 312 which receives an electric current generated in the working electrode 311 is electrically connected to the output terminal of the differential amplifier 435.

Further, to the circuit 400, an electric power is provided by the battery 405 (V_{BAT}).

More specifically, as shown in FIG. 7, to the battery 405, the charge pump 410 configured to provide a charge pump voltage V_{CHP} obtained by boosting a voltage received from the battery 405 to other constituent components of the circuit 400 is coupled. For example, in this embodiment, the battery 405 is a 1.5 V battery, and by coupling the charge pump 410 thereto, the voltage is boosted to 3.0 V as an output from the charge pump 410, and thereafter, the boosted voltage of 3.0 V is supplied to the differential amplifier 415, the differential amplifier 435, the preamplifier 420, the analog-to-digital converter 425, the reference generator 430, and the amplifiers 440 and 445.

Among these, the amplifiers 440 and 445 are configured with very high input impedance (for example, 100 GΩ), and input a guard voltage with low output impedance to a guard wiring which guards a wiring included in the circuit 400 as described in detail later.

In this embodiment, the differential amplifier 415 provides a fixed potential/voltage of, for example, 2 V±20 μV to the working electrode 311, and further converts a current signal into a measurable voltage through a resistor 450 which is part of the differential amplifier (transimpedance amplifier) 415 from the output of the differential amplifier 415.

Further, the circuit 400 includes a capacitor 455 coupled in parallel to the resistor 450 for a voltage signal at the output of the differential amplifier 415. Then, the voltage signal at the output of the differential amplifier 415 is supplied to the optional preamplifier 420. At this time, in this embodiment, the preamplifier 420 buffers the received voltage signal and provides the buffered voltage signal to the analog-to-digital converter 425. Thereafter, the analog-to-digital converter 425 outputs the converted signal to the processing circuit 200 (see FIG. 1) for further processing.

In this embodiment, the preamplifier 420 has high impedance (for example, 1 GΩ) so as to compensate for any signal variation in the output of the differential amplifier 415 to be input to the preamplifier 420, and thus, the accuracy of the converted signal is improved.

Further, as shown in FIG. 7, the reference generator 430 is electrically connected to each of the non-inverting input (terminal) of the differential amplifier 415 and the non-inverting input (terminal) of the differential amplifier 435, and at this time, the reference generator 430 supplies two input voltages of 2 V±20 μV and 1.4 V±20 μIV to the differential amplifier 415 and the differential amplifier 435, respectively. Therefore, a 600 mV difference is maintained between the working electrode 311 and the reference electrode 313.

The reference generator 430 is an electronic circuit which outputs a fixed reference voltage regardless of the power supply voltage, the temperature, or the variation in elements. Here, the “reference voltage” is the two input voltages of 2 V±20 μV and 1.4 V±20 μV.

More specifically, the voltage of the differential amplifier 435 is controlled to 1.4 V±20 μV, which is lower by 600 mV than 2 V at which the differential amplifier 415 is maintained, and this difference of 600 mV is maintained between the working electrode 311 and the reference electrode 313. This difference becomes an applied voltage to the detection section 300, and as a result, hydrogen peroxide contained in the sensing layer 321 is electrically decomposed, whereby electrons are generated. Since an electric current generated by the decomposition of hydrogen peroxide varies, the differential amplifier (servo amplifier) 435 changes its output so that the difference of 600 mV is maintained between the working electrode 311 and the reference electrode 313 of the detection section 300.

As shown in FIG. 7, the circuit 400 includes the amplifier 440 and the amplifier 445, each of which is constituted by a non-inverting amplifier circuit having a voltage amplification factor of 1 such as a unity gain amplifier or a voltage follower (buffer). Further, a guard wiring 441 and a guard wiring 446, each of which guards part of the circuit, are provided in a region indicated by a broken line circle of the wirings 314 and 132 connecting the working electrode 311 to the differential amplifier 415 and in a region indicated by a broken line circle of the wirings 314 and 132 connecting the reference electrode 313 to the differential amplifier 435, respectively. Each of the guard wiring 441 and the guard wiring 446 is formed so as to surround at least part of the wirings 314 and 132 connecting the working electrode 311 to the differential amplifier 415 and the wirings 314 and 132 connecting the reference electrode 313 to the differential amplifier 435, respectively, that is, at least part of portions with high impedance, through an insulating material. Then, among these, the amplifiers 440 and 445 receive the charge pump voltage V_{CHP} from the charge pump 410, and further, in this embodiment, the amplifier 440 is configured to maintain a zero voltage difference between the working electrode 311 and the guard wiring 441, and the amplifier 445 is configured to maintain a zero voltage difference between the reference electrode 313 and the guard wiring 446.

According to this, the occurrence of an electric leak is properly suppressed or prevented in the wirings 314 and 132 connecting the working electrode 311 to the differential amplifier 415 and the wirings 314 and 132 connecting the reference electrode 313 to the differential amplifier 435 due to the disturbance noise of static electricity or the like. In particular, when an electric leak occurs in the wirings 314 and 132 connecting the reference electrode 313 to the differential amplifier 435, the accuracy of the reference potential of the reference electrode 313 is lowered, and therefore, by properly suppressing or preventing the above-mentioned electric leak, the performance of the detection section 300 can be reliably maintained.

In particular, in the invention, the amplifier 440 is electrically connected to the wiring connecting the reference generator 430 to the non-inverting input of the differential amplifier 415, and further, the amplifier 445 is electrically connected to the wiring connecting the reference generator 430 to the non-inverting input of the differential amplifier 435. According to this, a guard voltage to be input to the guard wiring 441 formed on the wirings 314 and 132 connecting the working electrode 311 to the inverting input of the differential amplifier 415 is based on the non-inverting input voltage of the differential amplifier 415, and a guard voltage to be input to the guard wiring 446 formed on the wirings 314 and 132 connecting the reference electrode 313 to the inverting input of the differential amplifier 435 is based on the non-inverting input voltage of the differential amplifier 435. That is, a guard voltage to be output to the guard wiring is an output voltage of a circuit (a voltage follower circuit which performs impedance conversion) which operates by inputting the non-inverting input voltage of a differential amplifier included in the above-mentioned circuit as a reference voltage.

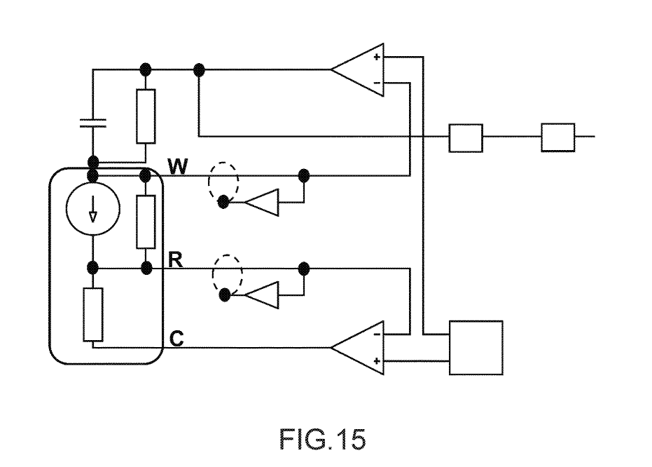

As for a guard voltage in the related art as shown in FIG. 15, a voltage is generated based on a voltage to be protected. To be more specific, the guard voltage is an output voltage of a circuit (a voltage follower circuit which performs impedance conversion) which operates by inputting a potential of a wiring connected to the electrode terminal of a load (sensor) to be controlled as a reference voltage. Due to this, it sometimes causes an increase in the noise for transitional response to signals. Immediately after the start of application of a voltage to a load (sensor), the voltage is likely to be indeterminate, and also noise is likely to be applied. Since variable components are included as the reference, the noise is likely to increase to lead to destabilization.

On the other hand, according to the invention, as shown in FIG. 7, the guard voltage to be input to the guard wirings 441 and 446 is based on the non-inverting input voltage of the differential amplifiers 415 and 435, and therefore, a signal line with stable and low impedance is used as the reference, and thus, the guard voltage is resistive to disturbance noise and is less likely to vary. Since variable factors are not included as the reference, the noise can be decreased and stabilization can be achieved. Due to this, even if the electric current of the sensor is decreased to a very low level, the sensor signal is not adversely affected by a leakage current and also the adverse effect of disturbance noise on the sensor signal can be properly suppressed or prevented, and therefore, the analysis device 101 can calculate a glucose level with excellent accuracy (sensitivity) for a long period of time. Further, by reducing the effect of noise, a method of decreasing the electric current value while maintaining the sensitivity also becomes possible, and by reducing the power consumption in the analysis device 101, the life of the battery can be prolonged.

### Second Embodiment

Next, a second embodiment of the analysis device according to the invention will be described.

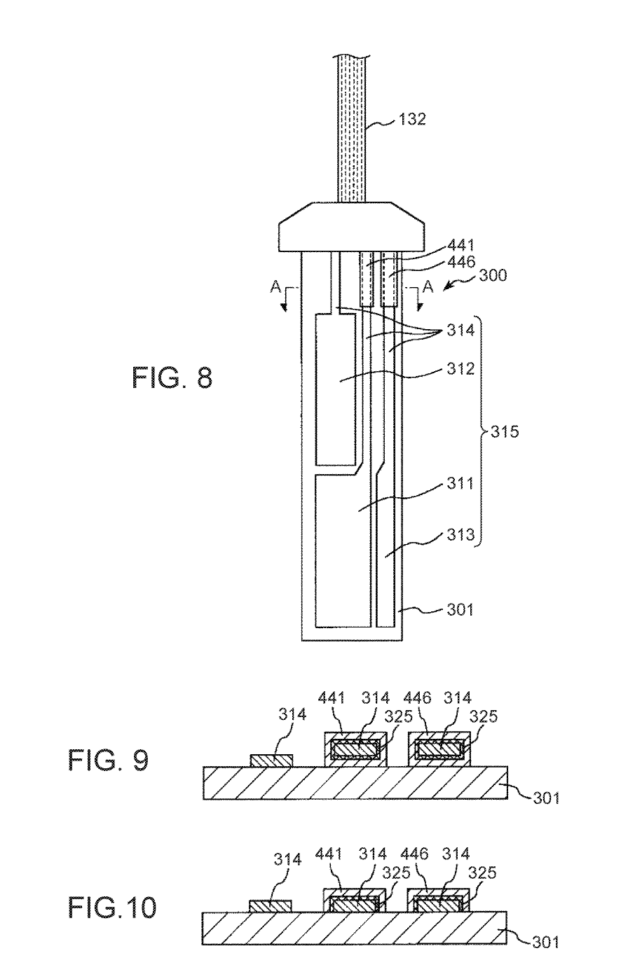

FIG. 8 is a plan view showing a detection section included in a detection element in the second embodiment of the analysis device according to the invention. FIG. 9 is a vertical cross-sectional view taken along the line A-A in FIG. 8. FIG. 10 is a vertical cross-sectional view showing another configuration example of the detection section included in the detection element in the second embodiment of the analysis device according to the invention.

Hereinafter, with respect to an analysis device 101 of the second embodiment, different points from the analysis device 101 of the first embodiment will be mainly described, and the description of the same matter will be omitted.

The analysis device 101 of the second embodiment is the same as the analysis device 101 shown in FIGS. 1 to 7 except that the configuration of the detection section 300 is different.

That is, in the analysis device 101 of the second embodiment, a guard wiring 441 and a guard wiring 446 are formed in the wiring 314 connecting the working electrode 311 to the differential amplifier 415 and the wiring 314 connecting the reference electrode 313 to the differential amplifier 435, respectively, in the wiring 314 included in the detection section 300. Then, these guard wirings (guard sections) 441 and 446 cover the wiring 314 in the form of a cover cylinder through an insulating layer 325. In this manner, by surrounding the wiring 314 which functions as a lead wiring of a sensor with the guard wiring, an electric current of the working electrode 311 and the reference electrode 313 is protected by the guard wirings 441 and 446 without coming into contact with the interstitial fluid and the skin tissues. Due to this, an electric current detected by the electrode layer 315 can be transmitted to the processing circuit 200 through the circuit 400 in a state where the occurrence of leakage is reduced.

Also by such an analysis device 101 of the second embodiment, the same effect as that of the first embodiment described above can be obtained.

The guard wirings (guard sections) 441 and 446 may be configured to cover a surface excluding a surface in contact with the substrate 301 with a covering layer with a concave shape through the insulating layer 325 without covering the wiring 314 in the form of a cover cylinder as shown in FIG. 10. That is, guard wirings 441 and 446 may be configured to cover part of the wiring 314. Even if the guard wirings 441 and 446 are configured to cover the surface with a covering layer with a concave shape in this manner, an electric current of the working electrode 311 and the reference electrode 313 can be protected by the guard wirings 441 and 446 without coming into contact with the interstitial fluid and the skin tissues. However, by configuring the guard wirings 441 and 446 to cover the wiring 314 in the form of a cover cylinder, an electric current of the working electrode 311 and the reference electrode 313 can be more reliably protected by the guard wirings 441 and 446 without coming into contact with the interstitial fluid and the skin tissues.

### Third Embodiment

Next, a third embodiment of the analysis device according to the invention will be described.

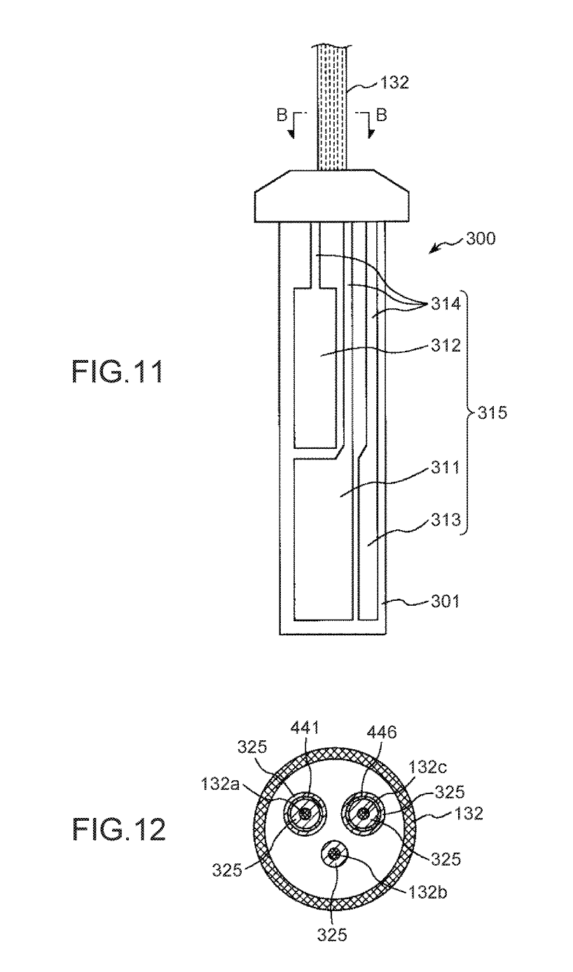

FIG. 11 is a plan view showing a detection section included in a detection element in the third embodiment of the analysis device according to the invention. FIG. 12 is a vertical cross-sectional view taken along the line B-B in FIG. 11.

Hereinafter, with respect to an analysis device 101 of the third embodiment, different points from the analysis device 101 of the first embodiment will be mainly described, and the description of the same matter will be omitted.

The analysis device 101 shown in FIG. 11 is the same as the analysis device 101 shown in FIGS. 1 to 7 except that the configuration of the detection section 300 is different.

That is, in the analysis device 101 of the third embodiment, a guard wiring 441 and a guard wiring 446 are formed in a wiring 132a connecting the working electrode 311 to the differential amplifier 415, and a wiring 132c connecting the reference electrode 313 to the differential amplifier 435, respectively, in the wiring 132 (132a, 132b, and 132c) coupled to the wiring 314 included in the detection section 300. Then, these guard wirings (guard sections) 441 and 446 cover the wirings 132a and 132c in the form of a cover cylinder through an insulating layer 325. Further, the insulating layer 325 covers the outer periphery. In this manner, by surrounding the wirings 132a and 132c, each of which functions as a lead wiring of a sensor, with the guard wirings 441 and 446, the wirings 132a and 132c are protected by the guard wirings 441 and 446 up to the input portion of the circuit 400 connected through the connector 131, and therefore, connection can be achieved without leakage. Due to this, highly accurate and stable sensing can be realized.

Also by such an analysis device 101 of the third embodiment, the same effect as that of the first embodiment described above can be obtained.

### Fourth Embodiment

Next, a fourth embodiment of the analysis device according to the invention will be described.

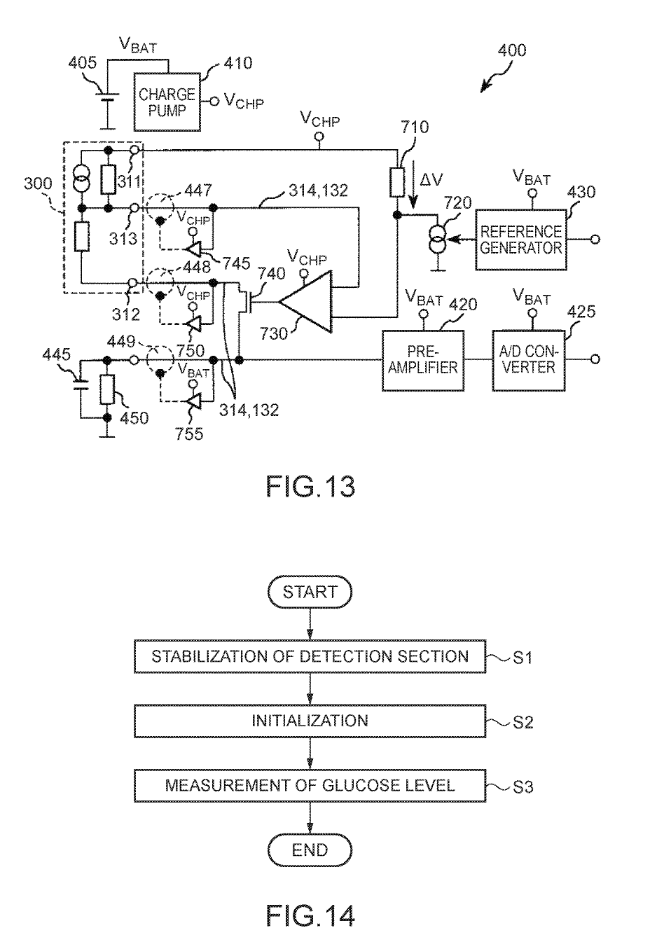

FIG. 13 is a view schematically showing a configuration of a circuit for driving a detection section included in a detection element in the fourth embodiment of the analysis device according to the invention.

Hereinafter, with respect to an analysis device 101 of the fourth embodiment, different points from the analysis device 101 of the first embodiment will be mainly described, and the description of the same matter will be omitted.

The analysis device 101 of the fourth embodiment is the same as the analysis device 101 shown in FIGS. 1 to 7 except that the configuration of the circuit 400 is different.

That is, in the circuit 400 of the analysis device 101 of the fourth embodiment, a current source 720 is operatively coupled to the reference generator 430 which operates at the voltage V_{BAT} of the battery 405. Further, the detection section 300 is biased by supplying an applied voltage of 600 mV by a resistor 710 operatively coupled to the working electrode 311 of the detection section 300.

Further, as shown in FIG. 13, the resistor 710 is connected between the working electrode 311 of the detection section 300 and the input of an amplifier 730. According to this, the amplifier 730 functions as a field effect transistor (FET) 740 and also as a current sink.

Specifically, the output of the amplifier 730 is coupled to the gate terminal of the FET 740, and on the other hand, the drain terminal of the FET 740 is coupled to the counter electrode 312, and further, the source terminal of the FET 740 is coupled to the preamplifier 420. In this manner, in this embodiment, in the signal path from the detection section 300 to the processing circuit 200 (see FIG. 1), the battery voltage (V_{BAT}) is supplied.

That is, as shown in FIG. 13, the voltage (V_{BAT}) of the battery 405 drives the reference generator 430 to provide a voltage necessary for the current source 720, and an applied voltage of 600 mV for biasing a sensor is generated. When an electric current flows through the resistor 710, an applied voltage is generated. As described above, the FET 740 and the amplifier 730 provide a current sink for the circuit 400, and this current sink allows the reference electrode 313 which is maintained at a charge pump voltage V_{CHP} of, for example, 3 V to be maintained at a voltage lower than the voltage of the working electrode 311 by 600 mV using a charge pump voltage (V_{CHP}) of, for example, 3 V. This is achieved by driving the gate terminal of the FET 740 with the output of the amplifier 730. At this time, the sensor current flows through the FET 740 to the resistor 450 and is input to the preamplifier 420 and then input to the analog-to-digital converter 425.

Further, as shown in FIG. 13, the circuit 400 includes amplifiers 745, 750, and 755, each constituted by a non-inverting amplifier circuit having a voltage amplification factor of 1 as a unity gain amplifier or a voltage follower (buffer). Further, a guard wiring 447, a guard wiring 448, and a guard wiring 449, each of which guards part of the circuit, are provided in a region indicated by a broken line circle of the wirings 314 and 132 connecting the reference electrode 313 to the amplifier 730, in a region indicated by a broken line circle of the wirings 314 and 132 connecting the counter electrode 312 to the FET 740, and in a region indicated by a broken line circle of the wirings 314 and 132 connecting the resistor 450 to the FET 740, respectively. Each of the guard wiring 447, the guard wiring 448, and the guard wiring 449 is formed so as to surround at least part of the wirings 314 and 132 connecting the reference electrode 313 to the amplifier 730, the wirings 314 and 132 connecting the counter electrode 312 to the FET 740, and the wirings 314 and 132 connecting the resistor 450 to the FET 740, respectively, through an insulating material. Then, the amplifiers 745 and 750 receive the charge pump voltage V_{CHP} from the charge pump 410, and further, the amplifier 755 receives the battery voltage V_{BAT} from the battery 405, and further, in this embodiment, the amplifier 745 is configured to be coupled to the guard wiring 447 and maintain a zero voltage difference between the reference electrode 313 and the guard wiring 447, the amplifier 750 is configured to be coupled to the guard wiring 448 and maintain a zero voltage difference between the counter electrode 312 and the guard wiring 448, and further, the amplifier 755 is configured to be coupled to the guard wiring 449 and maintain a zero voltage difference between the resistor 450 and the guard wiring 449.

In the analysis device 101 of the fourth embodiment as described above, at least part of the guard wiring (guard section) 447, the guard wiring (guard section) 448, and the guard wiring (guard section) 449 coupled to the wirings 314 and 132 connecting the reference electrode 313 to the amplifier 730, the wirings 314 and 132 connecting the counter electrode 312 to the FET 740, and the wirings 314 and 132 connecting the resistor 450 to the FET 740, respectively, have the same configuration as that of the guard wiring 441 and the guard wiring 446 described in the above second embodiment and the above third embodiment, and therefore, the same effect as that of the above second embodiment and the above third embodiment can be obtained.

### Measurement Method

The measurement of a glucose level in the interstitial fluid using the above-mentioned analysis device 101 is performed specifically, for example, as follows.

FIG. 14 is a flowchart showing a method for measuring a glucose level using the analysis device according to the invention.

[1] First, the cannula 111 is inserted into the subcutaneous tissue 502 and the detection section 300 (sensing layer 321) is brought into contact with the interstitial fluid and stabilized (S1).

[2] Subsequently, a fixed voltage is applied between the working electrode 311 and the reference electrode 313 for a predetermined period of time. By doing this, hydrogen peroxide generated in the vicinity of the working electrode 311 of the sensing layer 321 during stabilization is electrically decomposed as shown in the above formula (2), and as a result, the vicinity of the working electrode 311 of the sensing layer 321 is initialized (S2).

[3] Subsequently, after an interval of a fixed period of time, a fixed voltage is applied between the working electrode 311 and the reference electrode 313 for a predetermined period of time. By doing this, hydrogen peroxide generated in the vicinity of the working electrode 311 of the sensing layer 321 is electrically decomposed as shown in the above formula (2), and electrons generated by the electrical decomposition are measured as the value of an electric current flowing between the working electrode 311 and the counter electrode 312, whereby a glucose level in the interstitial fluid is obtained (S3).

At this time, in the measurement of a glucose level using the analysis device 101, a guard voltage to be input to the guard wirings 441 and 446 included in the circuit 400 is based on the non-inverting input voltage of the differential amplifiers 415 and 435, and therefore, the signal line with stable and low impedance is used as the reference, and thus, a glucose level can be calculated with excellent accuracy for a long period of time by the analysis device 101 without being adversely affected by a leakage current.

This step [3] may be performed once, however, by performing the step [3] repeatedly, and obtaining an average of the glucose levels measured during this period, the glucose levels are averaged, and thus, the glucose level can be obtained with higher reliability.

By performing the step [1] to step [3] as described above repeatedly at intervals of a fixed time, a glucose level (glucose concentration) in the interstitial fluid can be continuously measured.

Hereinabove, the analysis device and the analysis method according to the invention have been described with reference to the embodiments shown in the drawings, however, the invention is not limited thereto.

For example, the configurations of the respective components in the analysis device according to the invention can be replaced with an arbitrary configuration having a similar function. In addition, another arbitrary configuration may be added to the invention. Further, the invention may be configured such that arbitrary two or more configurations (features) of the above-mentioned embodiments are combined.

Further, the cannula may be inserted into the skin other than inserting the cannula into the subcutaneous tissue.

Further, with respect to the analysis device according to the invention, in the respective embodiments described above, a case where the invention is applied to a continuous glucose monitor (CGM) device in which a glucose level is continuously measured has been described, however, the invention is not limited thereto, and can also be applied to an analysis device which measures any target value as long as it is configured to include an electrode which induces a surface current and a circuit electrically connected to this electrode. Specifically, the invention can also be applied to, for example, an analysis device which continuously measures a lactic acid level, an antibody level, an enzyme level, or the like.

Further, one or more arbitrary steps may be added to the analysis method according to the invention.

The entire disclosures of Japanese Patent Application Nos. 2015-178232 filed Sep. 10, 2015 and 2016-110689 filed Jun. 2, 2016 are expressly incorporated by reference herein.

What is claimed is:

1. An analysis device, comprising:
an electrode which induces a surface current;
a circuit which is electrically connected to the electrode; and
a guard wiring which guards part of the circuit, wherein
a guard voltage to be input to the guard wiring is based on the non-inverting input voltage of a differential amplifier included in the circuit.

2. The analysis device according to claim 1, wherein the electrode includes a working electrode provided with an enzyme layer which senses glucose and a counter electrode which receives an electric current generated in the working electrode.

3. The analysis device according to claim 2, wherein the electrode further includes a reference electrode to be used for detecting the resistance of an electric current flowing through the working electrode.

4. An analysis device, comprising:
an electrode which induces a surface current;
a circuit which is electrically connected to the electrode; and
a guard section which covers part of the circuit.

5. The analysis device according to claim 4, wherein the guard section covers part of a wiring constituting the circuit in the form of a cover cylinder.

6. The analysis device according to claim 4, wherein the electrode includes a working electrode provided with an enzyme layer which senses glucose and a counter electrode which receives an electric current generated in the working electrode.

7. The analysis device according to claim 6, wherein the electrode further includes a reference electrode to be used for detecting the resistance of an electric current flowing through the working electrode.

8. An analysis method, which uses an analysis device including:
an electrode which induces a surface current;
a circuit which is electrically connected to the electrode; and
a guard wiring which guards part of the circuit, wherein
a guard voltage to be input to the guard wiring is based on the non-inverting input voltage of a differential amplifier included in the circuit, and a target measurement is calculated.
